(19) United States
(12) Patent Application Publication
(10) Pub. No.: US 2008/0143179 A1
(43) Pub. Date: Jun. 19, 2008

(54) Brake controller for a towed vehicle

(75) Inventor: James Wendell Rutherford, Grand Chenier, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(73) Assignee: Thomas McDaniel

(21) Appl. No.: 11/641,248

(22) Filed: Dec. 19, 2006

(51) Int. Cl. B60T 8/17; B60T 8/60

(52) U.S. Cl. 303/160; 701/70; 303/20

(57) ABSTRACT

A trailer brake controller for controlling a towed trailer braking system through the use of an independent processor mounted for communication between a towing vehicle braking system and a towed trailer braking system. The brake controller receives a signal indicative of the brake pressure applied by a user and relays the signal to the processor for processing and communication to the towed trailer braking system. A visual display positioned within visual range of the user allows the user to observe the status of the brake controller operations and adjust the output signal where necessary. A manual override allows the user to override the output signal generated by the controller and apply full braking power of the trailer to stop the trailer and the vehicle. A number of automatic overrides facilitate smooth operation of the brake controller by detecting abnormal conditions in the system connections and relaying the diagnosed conditions to the processor.

### BACKGROUND OF THE INVENTION

The present invention relates to a braking system for use with towed vehicle, and in particular, to a passenger vehicle trailer braking system controller.

The number of vehicles designed to tow trailers and other vehicles continues to increase, especially with the proliferation of sport utility vehicles. The ability of a vehicle to haul objects and equipment is often just as important factor in buyer's selection of a vehicle as the vehicle's ability to accommodate a certain number of passengers, the vehicle safety and performance.

To ensure safety, a towing vehicle and a towed vehicle must start and brake together. State and federal regulations require that towed vehicles over a certain gross vehicle weight, for instance trailer of 1,000 pounds and above, provide brakes on the trailer. Federal law also requires that the driver of the vehicle control the trailer's brakes. Many states require the use of an independent braking controller to actuate the trailer brakes so as to provide independent braking power to facilitate stopping of the vehicle/trailer combination.

Auto part manufacturers use various braking systems, such as hydraulic surge-brakes that use mechanical devices to actuate a brake cylinder, usually a master brake cylinder, in response to inertial pressure differential between the towing vehicle and the towed vehicle that develops upon deceleration of the vehicles. Other types of brakes used with towing vehicles include electrical brakes, electric over hydraulic, vacuum over hydraulic, and air over hydraulic.

While these types of braking systems may function well within their intended designs, there exists a need for a reliable brake controller that can be incorporated in the vehicle design at the time of the vehicle manufacture or sold in an after-market to be incorporated in the towing vehicle's main braking system, while providing override controls for increased safety and reliability. One desirable feature of such a braking system would be utilization of the trailer brakes as the major braking component of the vehicle in case of an emergency.

### SUMMARY OF THE INVENTION

It is, therefore, an object of the present invention to provide a brake controller system for use with a towed vehicle.

It is another object of the present invention to provide a brake controller system, wherein the towed vehicle braking system is a secondary braking system assisting and stabilizing the towing/towed vehicle combination, wherein the towed vehicle brake system is used in emergency situations in the event of towing vehicle brake system malfunction.

It is a further object of the present invention to provide a trailer braking controller with one or more overrides in response to a signal received from a pressure sensor operationally connected to the vehicle braking device.

These and other objects of the invention are achieved through a provision of a brake controller and a method of controlling a towed trailer braking system through the use of an independent processor mounted for communication between the towing vehicle braking system and the towed trailer braking system. According to the instant method, a pressure sensor determines the towing vehicle braking value and relays the braking value to an independent processor mounted in communication with the towing vehicle braking system.

An independent display allows the user to observe the data indicative of the diagnostic status of the controller and fault conditions existing in the connection between the braking systems of the towing vehicle and the towed trailer. The generated data is sent to the microcontroller/processor for processing the relayed data to determine a trailer brake output signal. The trailer brake output signal is then sent to the towed trailer braking system.

The system of the present invention provides for a number of overrides upon detection of abnormal conditions in the connection between the braking systems or failure of the towing vehicle braking system. Should the vehicle braking system fail, the user can manually override the controller signal and apply the full force of the trailer braking system to stop the trailer and the vehicle.

The abnormal conditions are present, for instance, when controller receives a signal from an open circuit detector indicative of faulty connection between the towed trailer braking system and the processor, or when a short circuit detector detects an electrical short in electrical connection of the towed trailer braking system and the processor.

Fault detector also generates a signal in the event of pressure failure in the vehicle braking system and communicates the generated signal to the processor. Another fault detector detects when the pressure sensor, connected to the vehicle brake master cylinder detects a failed connection between the processor and the pressure sensor and communicates the detected data to the processor.

### BRIEF DESCRIPTION OF THE DRAWINGS

Reference will now be made to the drawings, wherein like parts are designated by like numerals, and wherein

FIG. 1 is a schematic view of a braking controller system of the present invention.

FIG. 2 is a block diagram of an embodiment of the brake controller system of the present invention.

### DETAIL DESCRIPTION OF THE PREFERRED EMBODIMENT

Turning now to the drawings in more detail, numeral 10 designates the brake controller system of the present invention. The trailer brake controller 10 is configured and designed for incorporation with a passenger vehicle braking system. The brake controller system 10 can be integrated in the vehicle braking system by a vehicle manufacturer or by specialized vehicle service. Preferably, incorporation of the trailer brake controller 10 into the vehicle at the manufacturing stage, can make the brake controller display (described in more detail hereinafter) a part of the dash board instrument panel and make the display readily available to the driver.

When an existing vehicle is retrofitted to incorporate the controller 10 of the instant invention, it is envisioned that the display screen will be built into the front panel 11 of the brake controller itself. Other than the pressure sensor (described below) located under the vehicle hood, all components of the brake controller 10 are self contained. The brake controller body is mounted in the vehicle cab compartment near the driver's reach. An alternative would be to place the amplifier (described hereinafter) inside the pressure sensor. This alternative may not be as cost effective as other alternatives mentioned above.

In order to operate the components of the system, the brake controller system 10 comprises a processing device, such as a microcontroller/processor 12, which controls the system 10 operation. As used herein, the term “processor” may include a general-purpose processor, a microcontroller (e.g., an execution unit with memory, etc., integrated within an integrated circuit), a digital signal processor (DSP), a programmable logic device (PLD) or an application specific integrated circuit (ASIC), among other processing devices. The processor has sufficient memory to contain the software requirements to operate the system and required functionality for interpreting vehicle and driver inputs. It must also have the capabilities to provide proper control to the brakes of the towed vehicle/trailer and communication to the display unit accessible to the driver.

The microcontroller/processor 12 performs program software/firmware execution, input signal monitoring, timing calculations, logical decision making, output controls, and user interface updates. The amplified signal from the pressure sensor is converted from an analog value to a digital value which allows for very precise monitoring of vehicle hydraulic brake pressure. The microprocessor is operationally connected to the vehicle brake pedal 14 through suitable wiring (not shown). The brake pedal 14 is part of standard vehicle equipment. A driver actuates the vehicle brakes by applying pressure on the pedal 14. The more pressure is applied—the greater braking power is realized within the brake master cylinder 16. A typical hydraulic brake master cylinder 16 distributes hydraulic brake fluid to the vehicle brake system. Hydraulic pressure varies depending on the amount of force the driver applies to the brake pedal 14. The brake controller 10 employs the same hydraulic relationship to control the separate electric trailer brakes of a towed trailer 20.

The brake controller unit 10 generates an output signal received from the towing vehicle through hard-wired inputs from a brake pressure sensor 22, which is operably connected to the brake master cylinder 16. The pressure sensor 22 is attached to the brake master cylinder 16, allowing the brake controller unit 10 to monitor brake master cylinder hydraulic pressure. The pressure sensor 22 converts hydraulic pressure to an electrical signal. The signal cable 24 between the pressure sensor 22 and the brake controller unit 10 helps to minimize electrical noise in the vehicle engine compartment. This allows the brake controller 10 to sense and monitor vehicle braking activity to control the separate electric trailer brakes.

To facilitate transmittal of the signal from the pressure sensor 22 to the processor 12, the system of the present invention provides for the use of an amplifier 26 connected between the pressure sensor 22 and the microcontroller/processor 12. The amplifier 26 minimizes the effects of electrical noise generated by the towing vehicle electrical components and amplifies the raw signal inside the pressure sensor to a pre-determined value to be detectable by the microcontroller 12. The pressure sensor signal is preferably amplified (scaled) to be compatible with the microcontroller's analog input. Alternatively, the amplifier 26 may be incorporated in the pressure sensor body, if desired.

The proprietary software/firmware in the microcontroller 12 processes pressure sensor data and provides an output signal to output drivers 28 which ultimately control the separate electric trailer brakes. In the event of a computer crash, the microcontroller 12 will restart itself automatically. The microcontroller 12 also performs several other complex tasks thousands of times per second as will be described below.

The output drivers 28 use the control signal from the microcontroller 12 to control the separate electric trailer brakes. Powerful high current transistors are used to pulse the electric trailer brake coils more than 2000 times per second using complex timing calculations from the microcontroller 12. Each pulse delivers the full battery voltage available for maximum smooth and stable trailer braking power.

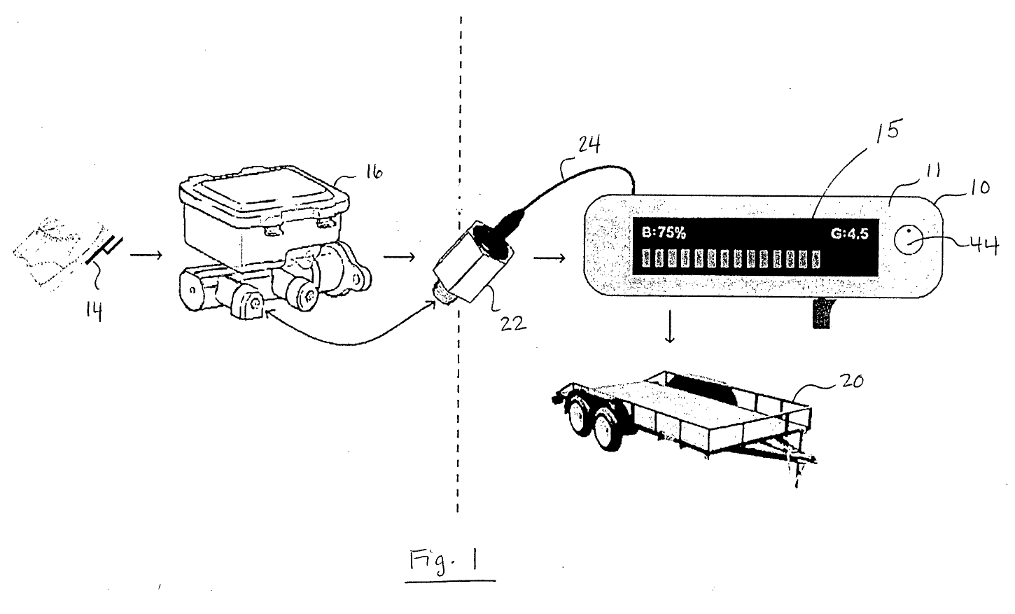

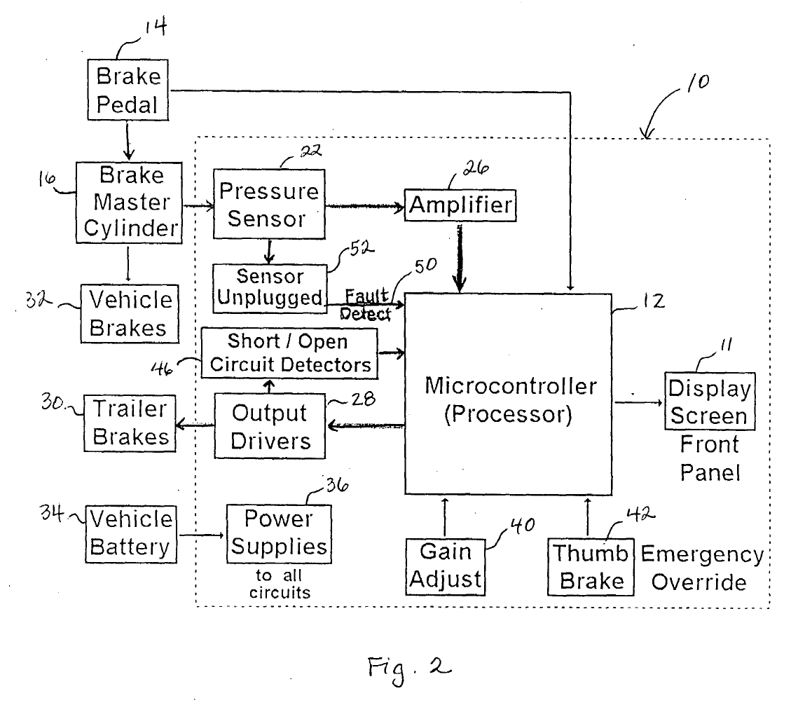

The brake controller system 10 comprises a visual communication device or visual display 15, which provides the user with status information about all aspects of the brake controller system 10. The display 15 provides gain display and a signal strength display (See, FIG. 1). The microcontroller 10 updates the displayed data dozens of times per second. The display screen also alerts the user of faults and error conditions in the trailer brakes. As can be seen in FIG. 2, the microprocessor receives input from the brake pedal 14, an amplifier 26, pressure sensor 22, a number of condition detectors, such as fault detector 50, and circuit detectors 46. Gain adjust circuitry 40, as well as an emergency override device 42 also provide input data for processing by the microcontroller 12.

The output drivers 28 send processed signal to the electric trailer brakes 30, which are separate from the vehicle brakes 32. Each trailer brake 30 is actuated by an electromagnetic coil. The brake controller 10 modulates the coil to control trailer braking action.

The towing vehicle battery 34 supplies electric power to the brake controller 10. This supply is preferably negative grounded with a nominal output voltage of +12 VDC. The brake controller 10 can accept an input supply voltage between +10.5 VDC and +20 VDC. The towing vehicle provides its own protection circuitry to prevent damage to the brake controller 10. A protective fuse or circuit breaker (not shown) is connected between the towing vehicle battery 34 and the brake controller 10.

The brake controller unit 10 also contains an independent internal power supply 36, which provides the necessary electric power to all circuits inside the brake controller unit, as well as to the pressure sensor 22.

The unit 10 also includes a gain adjust device 40 to facilitate fine-tuning of the trailer brake response. Gain adjust device 40 is operationally connected to the processor 12 through suitable wiring (not shown). The user may adjust the gain for individual preferences at any time. The microcontroller 10 recalculates the brake output signal based on the pressure sensor value and the gain value. The gain value range is 0.00 to 10.00 and is fully adjustable.

The system of the present invention provides for a number of override control conditions. One of the main overrides that are present on the faceplate of the brake control unit is a thumb brake device, or manual override control 42, which is operationally connected to the processor 12. The thumb brake device 42 allows the user to override the brake microcontroller 12 in emergency situations where maximum and immediate full trailer braking power may be needed. The thumb brake manual override device 42 is fully adjustable and provides status information to the user on the display screen 15.

The thumb brake signal has the highest priority in the brake controller system 10 and allows the user to manually control the electric trailer brakes without any restrictions. While the thumb brake switch 44 is manually pressed, the brake controller 10 will ignore the pressure sensor 22, a signal from gain adjust device 40, and all fault detection conditions and cause full braking power to be generated by the towed trailer braking system. The microcontroller 12 constantly monitors the thumb brake signal and applies variable proportional braking power to the electric trailer brakes.

In addition to the manual emergency control 42, the present invention provides for diagnostic input of out-of-range conditions in communication with the processor 12. The diagnostic input verifies proper operation of the towed trailer and executes corrective actions, where necessary and/or alerts the user of the out-of-range conditions.

The system of the present invention provides for four automatic safety overrides integrated into the brake controller system 10. The fault detection circuits monitor the vehicle and trailer brake wiring to alert the user when an abnormal or unsafe condition exists. Fault detection is a combination of functions of specialized circuitry 46, mounted between the output drivers 28 and the processor 12, and of microcontroller software/firmware processing. The four types of automatic fault detection in the brake controller 10 are: open circuit fault, short circuit fault, vehicle hydraulic pressure failure fault detector 50, and pressure sensor disconnect fault detector 52, which are supported by individual detectors, or detector circuitry.

“Open circuit fault” indicates that the brake wiring is in a loose, intermittent, or disconnected state which may result in intermittent, weak, or no trailer braking power. “Short circuit fault” indicates that an electrical short in the trailer may cause an electrical fire and result in no or limited trailer braking power. “Vehicle hydraulic pressure failure fault” indicates that the vehicle may have little or no hydraulic pressure to operate the vehicle brakes. “Pressure sensor disconnected fault” indicates that the pressure sensor 22 is not connected to the brake controller 10. In each of these four methods of fault detection, the brake controller 12 is programmed to alert the user and automatically take corrective action in an attempt to provide the safest possible functionality.

The “open circuit” detector monitors the electric trailer brakes for abnormal conditions indicative of intermittent trailer brake wiring, weak connection or disconnected trailer brake wires. The signal from the open circuit detector 46 is sent to the microcontroller 12. The microcontroller software/firmware decides if an open circuit fault is indicated and alerts the user via the display screen 15.

In an embodiment of the fault detector circuitry, the open circuit fault detector utilizes a high impedance detector hardware circuit which is connected to the microcontroller 12. A very weak test signal is sent through the trailer brake coils. The high impedance detector measures the test signal to determine if the trailer wiring is loose, intermittent, or disconnected. The microcontroller 12 then processes the test signal and compares the test result to a predetermined pass/fail limit value. If the result is within normal parameters, no fault is indicated. If the result is outside of the pre-determined normal parameters, the user is alerted via the display screen 15 until the fault is corrected.

The trailer brake output is not limited or restricted with this fault since the chance of an electrical fire is reduced for an open circuit fault. If open circuit fault is indicated, the user is advised to check all wires and harnesses in the vehicle/trailer brake wiring for possible dirty, loose, or broken electrical connections. The open circuit fault detection data is shown as “normal” if no trailer is connected to the vehicle and brake controller.

The “short circuit” fault detector 46 utilizes a custom DC current detector hardware circuit, which monitors the electrical current passing through the trailer brakes wiring and alerts of abnormal conditions, such as shorted trailer brake wiring or damaged trailer brake wiring, which may cause unsafe current draw. The signal from the short circuit detector 46 is sent to the microcontroller 12. The microcontroller 12 software/firmware decides if a short circuit fault is indicated. The microcontroller 12 processes the output of the current detector and compares the result to predetermined pass/fail limits. If the result is within normal parameters, no fault is indicated. If the result is outside of the pre-determined normal parameters, the user is alerted via the display screen 15. In the event of a short circuit, the microcontroller will safely limit the current available to the electric trailer brakes to prevent or greatly reduce the chance of a vehicle or trailer electrical fire caused by defective trailer brake wiring.

It is preferred that the trailer brake output is restricted to not more than 25 Amperes until the fault is corrected. This safety restriction, in conjunction with the 30 Ampere vehicle fuse or circuit breaker, helps reduce or prevent the possibility of an electrical fire while otherwise allowing normal operation. If short circuit fault is indicated, the user is advised to check all wires and harnesses in the vehicle/trailer brake wiring for damaged or shorted electrical connections.

“Hydraulic pressure failure” circuitry allows for trailer braking in the event that the vehicle braking system has lost hydraulic pressure. In such an emergency, the trailer could provide crucial braking assistance, even though the pressure sensor reads zero. The hydraulic pressure failure fault detection is performed by the pre-programmed operation of the microcontroller 12.

If the microcontroller detects that the brake pedal 14 has been pressed, but hydraulic brake pressure remains at zero (the pressure sensor 22 still reads zero after a preset interval of about 3-5 seconds) this indicates an emergency situation that the vehicle hydraulics have failed. The processor 12 than causes a slow increase in electric trailer brake output to accomplish the stop function. The microcontroller 12 will gradually increase trailer braking power within a preset interval of less than 10 seconds, allowing the user to use the trailer brakes to assist in stopping the vehicle as long as the brake pedal 14 is still pressed. This will allow the electric trailer brakes to attempt to slow the vehicle down in the event of vehicle hydraulic brake pressure failure. The user is alerted to this condition on the display screen 15. If pressure failure is indicated, the user is advised to check the vehicle hydraulic brake system for proper operation.

If the opposite condition is true (pressure sensor active and brake pedal switch is “off”), the user will be alerted that the brake pedal switch may be inoperative, which could mean that the vehicle's brake lights may not be functioning due to a defective brake pedal switch.

The “sensor unplugged” circuitry allows the microcontroller 12 to detect whether or not the pressure sensor 22 is plugged into the brake controller 10 or if the pressure sensor cable 24 is damaged. In the event that the sensor cable 24 is cut or damaged, the microcontroller 12 will alert the user that the sensor 22 is unplugged. In this state, the brake controller will not provide braking action to the trailer brakes, since vehicle brake pressure cannot be determined by a disconnected pressure sensor 22. The display screen 15 incorporated in the body of the brake controller unit is constantly updated with the brake controller status and also alerts the user with fault detection and override information. Unless the user employs the manual override 42 (thumb brake), the brake controller 10 will not attempt to apply the electric trailer brakes while in the “sensor unplugged” fault condition.

The controller unit 10 contains the memory functionality to log diagnostic error information for review by a service technician. This information can then be reviewed by a service technician in diagnosing failure modes in the brake control unit or the braking devices and perform the necessary repairs.

Many other changes and modifications can be made in the design of the present invention without departing from the spirit thereof. I therefore pray that my rights to the present invention be limited only by the scope of the appended claims.

I claim:

1. A trailer brake controller apparatus for use in a passenger vehicle for controlling braking of a towed trailer comprising:
a processor positioned within the passenger vehicle and in communication with a vehicle braking system;
a pressure sensor mounted between the vehicle braking system and said processor; and
a trailer brake output, said trailer brake output controlled by said processor in response to said vehicle brake pressure input.

2. The apparatus of claim 1, further comprising a diagnostic input in communication with said processor, said diagnostic input verifying within-range conditions of the vehicle braking system, detecting out-of-range conditions in the vehicle braking system, and detecting connection between the vehicle braking system and the towed trailer braking system.

3. The apparatus of claim 1, further comprising an output driver means for sending processed signal from the processor to the towed trailer braking system.

4. The apparatus of claim 1, further comprising a user emergency override control operationally connected to the processor, said user emergency override control being adapted to override signal sent by the processor to the towed trailer braking system and cause full braking power to be generated by the towed trailer braking system.

5. The apparatus of claim 4, further comprising a visual display means, said visual display means providing status information to the user about the trailer braking system and alerting the user to out-of-range conditions in the trailer braking system.

6. The apparatus of claim 5, wherein said display means comprises a display screen and houses a switch of the user emergency override control.

7. The apparatus of claim 5, wherein said display means provides a gain display and a brake output level.

8. The apparatus of claim 1, further comprising a pressure sensor mounted between the vehicle braking system and the processor for transmitting a signal generated by the vehicle braking system to the processor, said pressure sensor signaling said processor when the vehicle braking system is activated.

9. The apparatus of claim 8, further comprising fault detection means providing an input signal to the processor of detected abnormal conditions in communication between the vehicle braking system and the towed trailer braking system.

10. The apparatus of claim 9, wherein said fault detection means comprises an open circuit detector, a short circuit detector, a pressure failure detector and a pressure sensor disconnect detector.

11. The apparatus of claim 9, wherein said open circuit detector detects an abnormal condition in electrical connection between the towed trailer braking system and the processor.

12. The apparatus of claim 9, wherein said short circuit detector detects an electrical short in electrical connection of the towed trailer braking system and the processor.

13. The apparatus of claim 9, wherein said pressure failure detector detects abnormal condition in the vehicle braking system, generates a signal indicative of the abnormal condition in the vehicle braking system and communicates said generated signal to the processor.

14. The apparatus of claim 9, wherein said pressure sensor disconnect detector detects a failed connection between the processor and the pressure sensor and communicates the detected data to the processor.

15. The apparatus of claim 8, further comprising an amplifier mounted between the pressure sensor and the processor for amplifying the signal generated by the pressure sensor.

16. The apparatus of claim 1, further comprising a gain adjust device for user adjustment of the operation of the towed trailer braking system.

17. A method of controlling a towed trailer braking system comprising the steps:
determining a towing vehicle braking value through a connection to the towing vehicle braking system;
relaying data about the towing vehicle braking value to an independent processor mounted in operational communication with the towing vehicle braking system;
providing a display means for providing visual data about status of the relayed data to the user;
processing the relayed data to determine a trailer brake output signal; and
sending said trailer brake output signal to the towed trailer braking system.

18. The method of claim 17, wherein said display means comprises a display screen positioned within visual range of the user.

19. The method of claim 17, further comprising a step of adjusting the output signal based on user preferences by adjusting gain of the output signal prior to sending the output signal to the towed trailer braking system.

20. The method of claim 17, further comprising a step of providing an emergency override device for user overriding of the output signal generated by the processor.

21. The method of claim 17, further comprising the step of diagnosing an abnormal condition in communication between the towed trailer braking system and the towing vehicle braking system, generating a signal indicative of the abnormal condition and alerting the user of the abnormal condition through the use of the display means.

22. The method of claim 21, wherein said step of diagnosing abnormal conditions comprises providing a pressure sensor mounted between the vehicle braking system and the processor for transmitting a signal generated by the towing vehicle braking system to the processor, said pressure sensor signaling said processor when the towing vehicle braking system is activated.

23. The method of claim 22, further comprising the step of providing fault detection means for generating a signal to the processor of detected abnormal conditions in communication between the towing vehicle braking system and the towed trailer braking system.

24. The method of claim 23, wherein said fault detection means comprises an open circuit detector, a short circuit detector, a pressure failure detector and a pressure sensor disconnect detector.

25. The method of claim 23, wherein said open circuit detector detects an abnormal condition in electrical connection between the towed trailer braking system and the processor.

26. The method of claim 23, wherein said short circuit detector detects an electrical short in electrical connection of the towed trailer braking system and the processor.

27. The method of claim 23, wherein said pressure failure detector detects abnormal condition in the vehicle braking system, generates a signal indicative of the abnormal condition in the vehicle braking system and communicates said generated signal to the processor.

28. The method of claim 23, wherein said pressure sensor disconnect detector detects a failed connection between the processor and the pressure sensor and communicates the detected data to the processor.
